(19) United States
(12) Patent Application Publication
(10) Pub. No.: US 2022/0183923 A1
(43) Pub. Date: Jun. 16, 2022

(54) MASSAGE MACHINE WITH LIMB MASSAGE MECHANISM AND WORKING METHOD OF LIMB MASSAGE MECHANISM

(71) Applicant: Aidepingfang Health Technology (Shanghai) Co., Ltd., Shanghai (CN)

(72) Inventor: YUICHI OKAMOTO, Shanghai (CN)

(21) Appl. No.: 17/425,321

(22) PCT Filed: Dec. 4, 2019
(86) PCT No.: PCT/CN2019/123044

§ 371 Date: Feb. 7, 2022

(30) Foreign Application Priority Data
Oct. 10, 2018 (CN) 201811179520.8

(51) Int. Cl. A61H 9/00

(52) U.S. Cl. CPC A61H 9/0078; A61H 2205/06; A61H 2201/1215; A61H 2201/1463

(57) ABSTRACT

A massage machine with a limb massage mechanism and a working method of the limb massage mechanism are disclosed. The limb massage mechanism includes a bracket, a support housing connected to the bracket, and a massage mechanism mounted in the bracket and the support housing. The massage mechanism includes a motor, a speed reducer, a first rotating shaft and multiple treatment pieces; the motor is connected to the speed reducer; the multiple treatment pieces are eccentrically arranged on the first rotating shaft, and are helically mounted on the first rotating shaft from ends close to the speed reducer to ends away from the speed reducer; and a side opposite to the treatment pieces is provided with an air bag which is disposed on the inner side surface of the support housing.

### CROSS-REFERENCE TO RELATED APPLICATIONS

This application is a 371 of International Patent Application Number PCT/CN2019/123044, filed on Dec. 4, 2019, which claims the benefit and priority of Chinese Patent Application Number 201811179520.8, filed on Oct. 10, 2018 with China National Intellectual Property Administration, the disclosures of which are incorporated herein by reference in their entireties.

### TECHNICAL FIELD

The present disclosure relates to the technical field of massage equipment, and more particularly relates to a massage machine with a limb massage mechanism and a working method of the limb massage mechanism.

### BACKGROUND

As illustrated in FIG. 1, a traditional massage machine 100 is provided with an arm massage device 200. The traditional arm massage device massages a person being treated in a manner of squeezing by upper and lower or left and right air bags, so that the massage mode is monotonous, and the person being treated has poor massage experience. Therefore, the present disclosure provides an arm massage mechanism that can realize various massage modes to improve the comfort level of massage and achieve a better therapeutic effect.

### SUMMARY

The technical problem to be solved by the present disclosure is that a limb massage mechanism of an existing massage machine has a monotonous massage mode.

In order to solve the above-mentioned technical problem, the technical solution of the present disclosure provides a limb massage mechanism, including a bracket, a support housing connected with the bracket, and a massage mechanism mounted in the bracket and the support housing. The massage mechanism includes a motor, a speed reducer, a first rotating shaft and several treatment pieces; the motor is connected with the speed reducer; the several treatment pieces are eccentrically arranged on the first rotating shaft, wherein the several treatment pieces are helically mounted on the first rotating shaft from ends close to the speed reducer to ends away from the speed reducer; a side opposite to the treatment pieces is provided with an air bag which is disposed on the inner side surface of the support housing.

Optionally, the output end of the motor is connected with the input end of the speed reducer; the output end of the speed reducer is provided with a power output shaft; and the treatment pieces are eccentrically mounted on the power output shaft.

Optionally, a driven wheel is mounted on the speed reducer; a drive wheel is mounted on the motor; and the drive wheel and the driven wheel are connected through a belt.

Optionally, a second rotating shaft is further included; the second rotating shaft and the first rotating shaft are arranged on two sides of the speed reducer; a first swing rod and a second swing rod are arranged on the second rotating shaft; and the end portion of each of the first swing rod and the second swing rod is eccentrically provided with at least one treatment piece.

Optionally, the bracket and the support housing are detachably mounted between two planes in a lengthwise direction in an acute angle, right angle or obtuse angle manner.

Optionally, a bearing end cover is further included, which is mounted in the bracket; and one end of the first rotating shaft is connected with the speed reducer, and the other end of the first rotating shaft is connected with the bearing end cover.

Optionally, bearings are further included, which are mounted between the first rotating shaft and the treatment pieces and used for supporting the treatment pieces and causing the treatment pieces to rotate on the rotating shaft.

Optionally, the axis of the first rotating shaft is parallel to a plane where the bracket is located and a plane where the support housing is located.

In order to solve the above-mentioned technical problems, the technical solution of the present disclosure further provides a massage machine including any of the above-mentioned arm massage mechanism.

In order to solve the above-mentioned technical problems, the technical solution of the present disclosure further provides a working method of an arm massage mechanism. The working method is as follows:

The motor is initiated to provide power to the speed reducer; the speed reducer controls the rotating shaft to rotate; the treatment pieces mounted on the rotating shaft rotate; and the treatment pieces pass through openings in the rotation process and are in contact with a treated part of the person being treated.

The beneficial effects of the technical solutions of the present disclosure are as follows:

the technical solution of the present disclosure cyclically massages the treated part of the person being treated under the driving of clockwise and anticlockwise rotations of the motor through the treatment pieces eccentrically helically arranged on the rotating shaft, thereby bringing a better massage feeling.

### BRIEF DESCRIPTION OF THE DRAWINGS

FIG. 1 is a schematic structural diagram of a massage machine in the prior art;

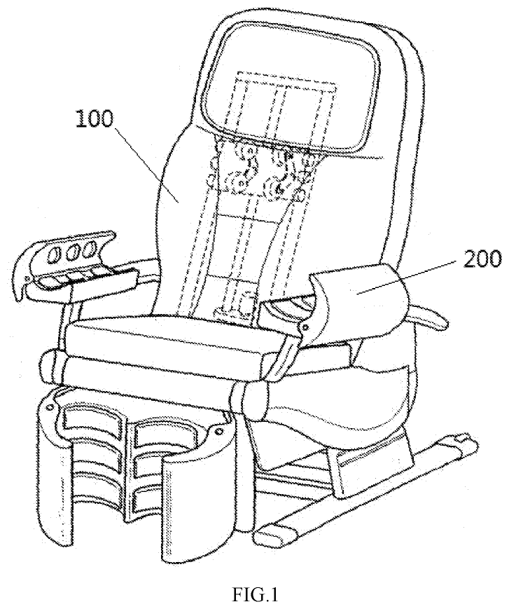

FIG. 2 is a schematic structural diagram of a limb massage mechanism of the present disclosure from one angle;

FIG. 3 is a schematic structural diagram of a limb massage mechanism of the present disclosure from another angle;

FIG. 4 is a schematic structural diagram of mounting of treatment pieces and a rotating shaft of the present disclosure;

FIG. 5 is a schematic structural diagram of one embodiment of a limb massage mechanism in the embodiments of the present disclosure and an armrest in a massage machine;

FIG. 6 is schematic structural diagrams of second embodiment of a limb massage mechanism in the embodiments of the present disclosure and an armrest in a massage machine;

FIG. 7 is schematic structural diagrams of third embodiment of a limb massage mechanism in the embodiments of the present disclosure and an armrest in a massage machine;

FIG. 8 is schematic structural diagrams of fourth embodiment of a limb massage mechanism in the embodiments of the present disclosure and an armrest in a massage machine;

FIG. 9 is schematic structural diagrams of fifth embodiment of a limb massage mechanism in the embodiments of the present disclosure and an armrest in a massage machine;

FIG. 10 is schematic structural diagrams of sixth embodiment of a limb massage mechanism in the embodiments of the present disclosure and an armrest in a massage machine;

FIG. 11 is another schematic structural diagram of treatment pieces and rotating shafts in the present disclosure;

FIG. 12 is another schematic structural diagrams of a massage mechanism in the present disclosure; and

FIG. 13 is another schematic structural diagrams of a massage mechanism in the present disclosure.

### DESCRIPTION OF THE EMBODIMENTS

The present disclosure is further described below in combination with the accompany drawings and specific embodiments that are not intended to limit the present disclosure.

In the description of the present utility model, unless otherwise explicitly specified and defined, the terms “installed”, “coupled” “connected” and “fixed” shall be understood broadly, and may be, for example, fixedly connected, or detachably connected, or integrally connected, or mechanically connected, or electrically connected, or directly connected, or indirectly connected through an intermediate medium, or interconnection between two elements. Those of ordinary skill in the art can understand the specific meanings of the above terms in the present utility model according to specific situations.

### Embodiment I

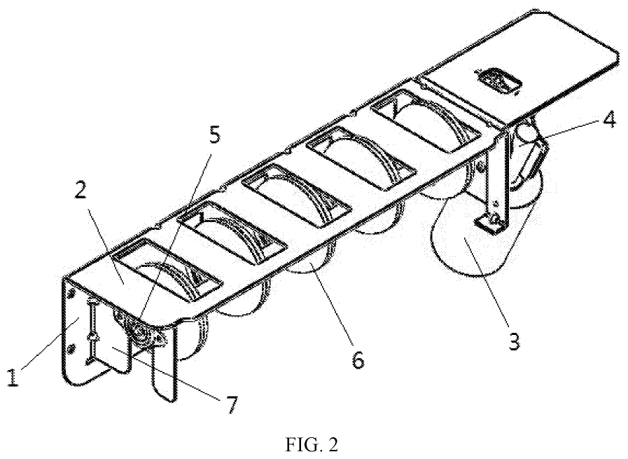

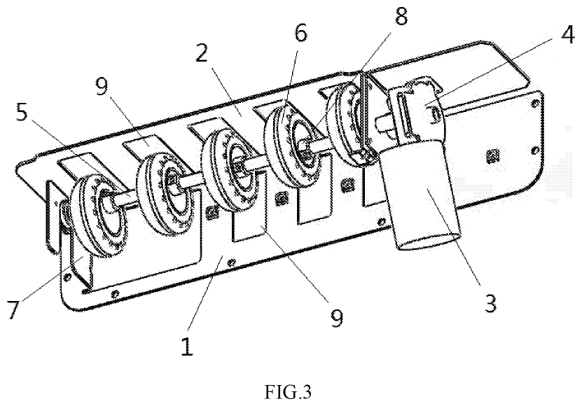

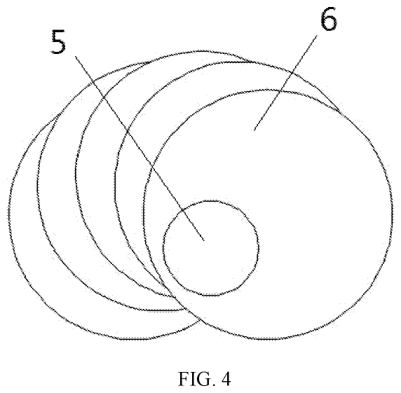

Referring to FIG. 2 and FIG. 3, a limb massage mechanism of one embodiment is illustrated, including a bracket 1, a support housing 2 connected with the bracket 1, and a massage mechanism mounted in the bracket 1 and the support housing 2. The massage mechanism includes a motor 3, a speed reducer 4, a rotating shaft 5 and several treatment pieces 6; the motor 3 is connected with the speed reducer 4; the output end of the speed reducer 4 is connected with the rotating shaft 5; the several treatment pieces 6 are eccentrically and uniformly arranged on the rotating shaft 5, wherein the several treatment pieces 6 are helically uniformly wound on the rotating shaft 5 from ends close to the speed reducer 4 to ends away from the speed reducer 4 (as illustrated in structures of the rotating shaft 5 and the treatment pieces 6 in FIG. 4, the treatment pieces 6 in FIG. 4 are helically arranged on the rotating shaft 5).

In the present embodiment, the bracket 1 and the support housing 2 are detachably mounted between two planes in a lengthwise direction in an acute angle, right angle or obtuse angle manner.

In the present embodiment, a bearing end cover 7 is further included, which is mounted in the bracket 1; and one end of the rotating shaft 5 is connected with the speed reducer 4, and the other end of the rotating shaft 5 is connected with the bearing end cover 7.

In the present embodiment, bearings 8 are further included, which are mounted between the rotating shaft 5 and the treatment pieces 6 and used for supporting the treatment pieces 6 and causing the treatment pieces 6 to rotate on the rotating shaft 5.

In the present embodiment, positions, corresponding to the treatment pieces 6, of the bracket 1 and the support housing 2 are provided with openings 9; distances between the treatment pieces 6 and the openings 9 are decreased or increased in order; and the treatment pieces 6 pass through the openings 9 in the rotation process.

In the present embodiment, the axis of the rotating shaft 5 is parallel to a plane where the bracket 1 is located and a plane where the support housing 2 is located.

The features and functions of the present disclosure are further illustrated by means of the following explanation.

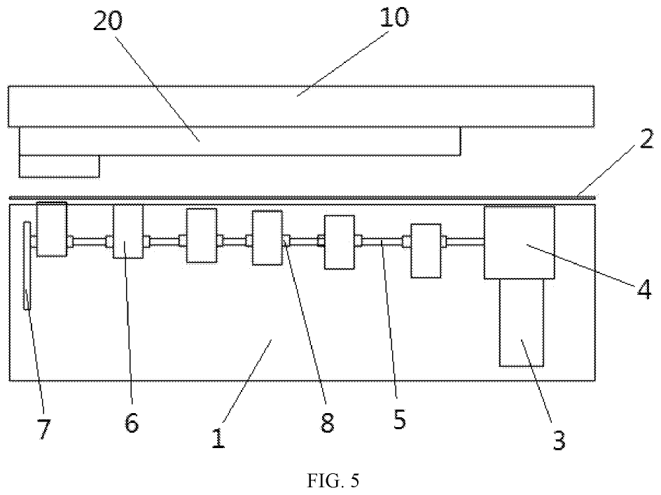

Referring to FIG. 2 to FIG. 4, in the present embodiment, a massage machine is further provided, including any of the foregoing limb massage mechanisms. A working method of a limb massage mechanism is also provided. Referring to FIG. 5, a schematic structural diagram of one embodiment of a limb massage mechanism in the embodiments of the present disclosure and an armrest in a massage machine is illustrated. The working method is that: a treated part of a person being treated is placed on the support housing 2 in the limb massage mechanism; an armrest 10 of the massage machine is disposed above the treated part; an air bag 20 is mounted at the bottom of the armrest 10; the air bag 20 presses an arm; the motor 3 is initiated to provide power to the speed reducer 4; the speed reducer 4 controls the rotating shaft 5 to rotate; the treatment pieces 6 mounted on the rotating shaft 5 rotate; and the treatment pieces 6 pass through openings (which are not shown in FIG. 5. The positions of the openings 9 are shown in FIG. 3) in the rotation process and are in contact with the treated part of the person being treated. The treatment pieces 6 massage the treated part in a cyclic peening manner. The treatment pieces 6 would massage the treated part in order one by one due to their helical structure.

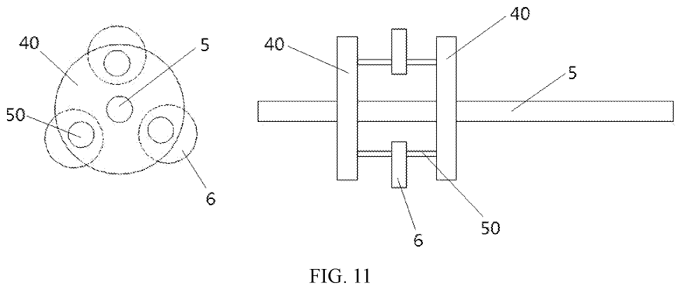

In addition, as illustrated in FIG. 11, a better massage feeling can be achieved by changing an assembling structure of the treatment pieces 6 and the rotating shaft 5. Specifically, a pair of circular mounting plates 40 is added on the rotating shaft 5; and several revolution shafts 50 are mounted on the circular mounting plates 40 in a circumferential direction. In the present embodiment, three revolution shafts are illustrative. One treatment piece 6 is eccentrically mounted on each revolution shaft 50 to form one treatment piece group; several treatment piece groups can be disposed on the rotating shaft 5. The rotating shaft 5 rotates to drive the circular mounting plates 40 to rotate in the same way, and the treatment pieces 6 synchronously rotate to be in contact with and massage the treated part of the person being treated.

### Embodiment II

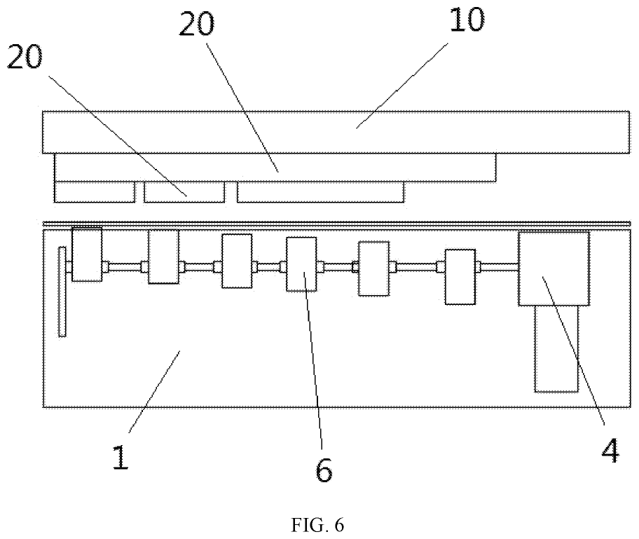

Referring to FIG. 6, in the present embodiment, the structure of the limb massage mechanism is the same as that of Embodiment I, but the only difference is that the number and arrangement of the air bags 20 at the bottom of the armrest 10. The limb massage mechanism in the present embodiment can also achieve the technical effects that are the same as Embodiment I. The specific implementation mode is the same as Embodiment I, and descriptions thereof are omitted here.

### Embodiment III

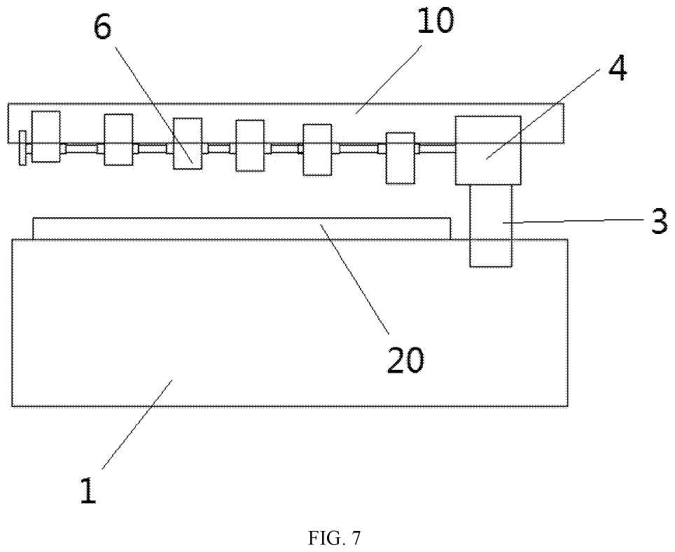

Referring to FIG. 7, in the present embodiment, the structure of the limb massage mechanism is the same as that of Embodiment I, but the only difference is that the position of the massage mechanism and the position of the air bag 20 are interchanged. The massage mechanism is disposed at the bottom of the armrest 10, and the air bag 20 is mounted on the bracket 1. The limb massage mechanism in the present embodiment can also achieve the technical effects that are the same as Embodiment I. The specific implementation mode is the same as Embodiment I, and descriptions thereof are omitted here.

### Embodiment IV

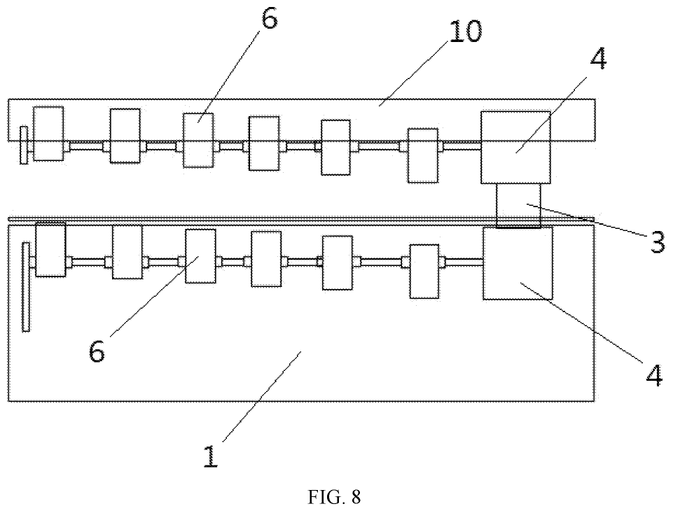

Referring to FIG. 8, in the present embodiment, the structure of the limb massage mechanism is the same as that of Embodiment I, but the only difference is that the air bag 20 at the bottom of the armrest 10 is replaced by another group of massage mechanism to realize a limb massage mechanism with two groups of massage mechanisms. The speed reducers 4 in the two groups of massage mechanisms are driven by the same motor 3. The limb massage mechanism in the present embodiment can also achieve the technical effects that are the same as Embodiment I. The specific implementation mode is the same as Embodiment I, and descriptions thereof are omitted here.

### Embodiment V

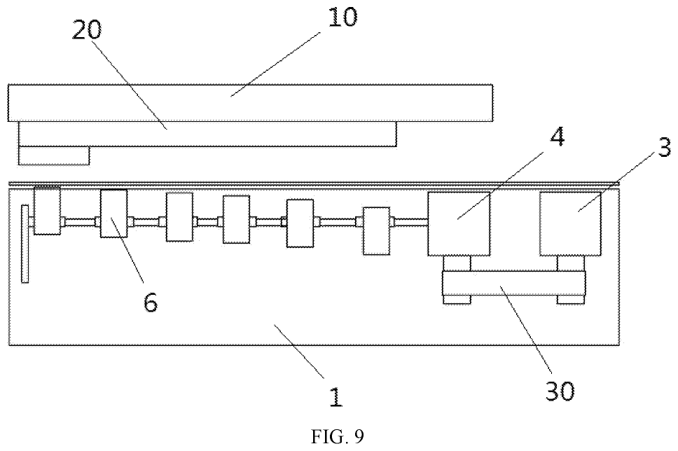

Referring to FIG. 9, in the present embodiment, the structure of the limb massage mechanism is the same as that of Embodiment I, but the only difference is that the driving mode between the motor 3 and the speed reducer 4 is changed from the original direct connection in Embodiment I into driving by a belt 30. The limb massage mechanism in the present embodiment can also achieve the technical effects that are the same as Embodiment I. The specific implementation mode is the same as Embodiment I, and descriptions thereof are omitted here.

### Embodiment VI

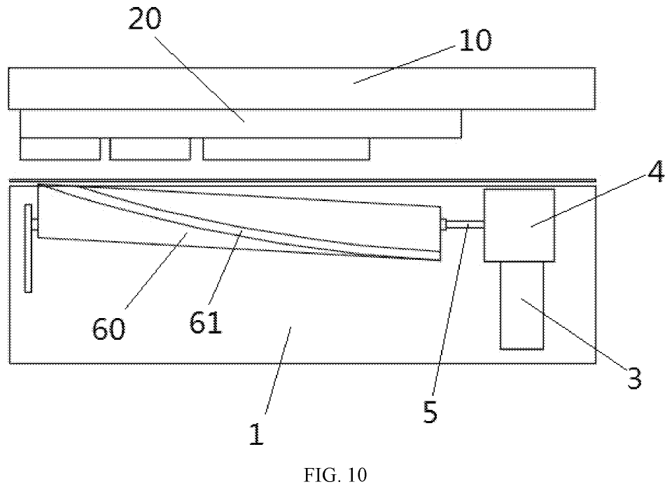

Referring to FIG. 10, in the present embodiment, the structure of the limb massage mechanism is the same as that of Embodiment I, but the only difference is that the several treatment pieces 6 in Embodiment I are replaced by an overall massage wheel 60. A gully 61 is helically formed in the massage wheel 60. Those skilled in the art can understand that the overall structure of the massage wheel 60 is twisted or like an electric drill. The limb massage mechanism in the present embodiment can also achieve the technical effects that are the same as Embodiment I. The specific implementation mode is the same as Embodiment I, and descriptions thereof are omitted here.

### Embodiment VII

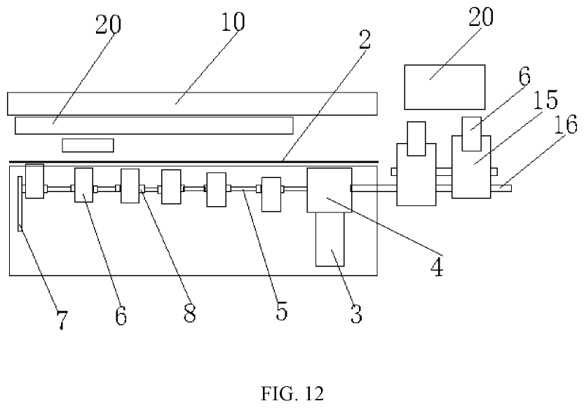

Referring to FIG. 12, a side opposite to the treatment pieces 6 is provided with an air bag 20 which is disposed on the inner side surface of the support housing. A second rotating shaft 16 is further included. The second rotating shaft 16 is arranged on the other side of the speed reducer 4; two swing rods 15 are arranged on the second rotating shaft 16; and the end portion of each of the swing rods 15 is provided with one treatment piece 6.

### Embodiment VIII

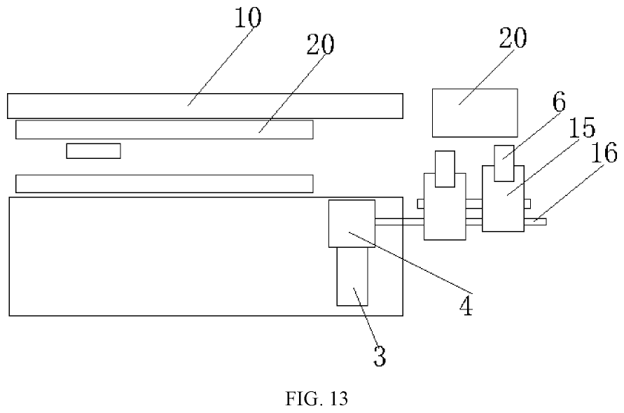

Referring to FIG. 13, two sides of arm placement positions are provided with air bags 20; a second rotating shaft 16 is arranged at a shoulder placement position; the second rotating shaft 16 is arranged on the outer side of the speed reducer 4; two swing rods 15 are arranged on the second rotating shaft 16; the end portion of each of the swing rods 15 is eccentrically provided with one treatment piece 6; and a part corresponding to the treatment piece 6 is provided with an air bag 20.

According to the above, the limb massage mechanism in the six embodiments aims to improve the massage feeling brought by the massage machine. The limb massage mechanism of a traditional massage machine realizes massage in a manner of squeezing by upper and lower or left and right air bags. The limb massage mechanism of the present embodiment makes use different structures to realize a better feeling; furthermore, clockwise rotation and anticlockwise rotation of the motor 3 can conform to the theories of a centripetal treatment and a telecardiography (centrifugation); and the present disclosure is protected by changing the positions of the treatment pieces 6 and the air bags 20 and the front and back placement positions or the number of the treatment pieces 6.

The foregoing merely depicts illustrative embodiments of the present disclosure, and do not therefore limit the implementations and protection scope of the present disclosure. Those skilled in the art should be able to appreciate that solutions obtained by equivalent replacements made by applying the specification of the present utility model and the contents of the drawings and apparent changes shall all fall within the protection scope of the present disclosure.

1. A limb massage mechanism, comprising a bracket, a support housing connected to the bracket, and a massage mechanism mounted in the bracket and the support housing, wherein the massage mechanism comprises a motor, a speed reducer, a first rotating shaft and a plurality of treatment pieces; wherein the motor is connected to the speed reducer; the plurality of treatment pieces are eccentrically arranged on the first rotating shaft, wherein the plurality of treatment pieces are helically mounted on the first rotating shaft from ends close to the speed reducer to ends away from the speed reducer; and a side opposite to the plurality of treatment pieces is provided with an air bag which is disposed on an inner side surface of the support housing.

2. The limb massage mechanism of claim 1, wherein an output end of the motor is connected to an input end of the speed reducer; an output end of the speed reducer comprises a power output shaft; and the treatment wheels are eccentrically mounted on the power output shaft.

3. The limb massage mechanism of claim 1, wherein a driven wheel is mounted on the speed reducer; a drive wheel is mounted on the motor; and the drive wheel and the driven wheel are connected through a belt.

4. The limb massage mechanism of claim 1, further comprising a second rotating shaft, wherein the second rotating shaft and the first rotating shaft are arranged on two sides of the speed reducer; a first swing rod and a second swing rod are arranged on the second rotating shaft; and the end portion of each of the first swing rod and the second swing rod is eccentrically provided with at least one treatment piece.

5. The limb massage mechanism of claim 1, wherein the bracket and the support housing are detachably mounted between two planes in a lengthwise direction in an acute angle, right angle or obtuse angle manner.

6. The limb massage mechanism of claim 1, further comprising a bearing end cover mounted in the bracket, wherein one end of the first rotating shaft is connected to the speed reducer, and another end of the first rotating shaft is connected to the bearing end cover.

7. The limb massage mechanism of claim 1, further comprising bearings which are mounted between the first rotating shaft and the treatment pieces and used for supporting the treatment pieces and causing the treatment pieces to rotate on the rotating shaft.

8. The limb massage mechanism of claim 1, wherein the axis of the first rotating shaft is parallel to a plane where the bracket is located and a plane where the support housing is located.

9. A massage machine, comprising a limb massage mechanism, wherein the limb massage mechanism comprises a bracket, a support housing connected to the bracket, and a massage mechanism mounted in the bracket and the support housing, wherein the massage mechanism comprises a motor, a speed reducer, a first rotating shaft and a plurality of treatment pieces; wherein the motor is connected to the speed reducer; the plurality of treatment pieces are eccentrically arranged on the first rotating shaft, wherein the plurality of treatment pieces are helically mounted on the first rotating shaft from ends close to the speed reducer to ends away from the speed reducer; and a side opposite to the plurality of treatment pieces is provided with an air bag which is disposed on an inner side surface of the support housing.

10. A working method of the limb massage mechanism according to claim 1, wherein the working method comprises:
initiating the motor to provide power to the speed reducer;
controlling, by the speed reducer, the rotating shaft to rotate;
rotating by the treatment pieces mounted on the rotating shaft; and
passing through the openings by the treatment pieces in the rotation process, wherein the treatment pieces are in contact with a treated part of a person being treated.

11. The massage machine of claim 9, wherein an output end of the motor is connected to an input end of the speed reducer; an output end of the speed reducer comprises a power output shaft; and the treatment wheels are eccentrically mounted on the power output shaft.

12. The massage machine of claim 9, wherein a driven wheel is mounted on the speed reducer; a drive wheel is mounted on the motor; and the drive wheel and the driven wheel are connected through a belt.

13. The massage machine of claim 9, wherein the limb massage mechanism further comprises a second rotating shaft, wherein the second rotating shaft and the first rotating shaft are arranged on two sides of the speed reducer; a first swing rod and a second swing rod are arranged on the second rotating shaft; and the end portion of each of the first swing rod and the second swing rod is eccentrically provided with at least one treatment piece.

14. The massage machine of claim 9, wherein the bracket and the support housing are detachably mounted between two planes in a lengthwise direction in an acute angle, right angle or obtuse angle manner.

15. The massage machine of claim 9, wherein the limb massage mechanism further comprises a bearing end cover mounted in the bracket, wherein one end of the first rotating shaft is connected to the speed reducer, and another end of the first rotating shaft is connected to the bearing end cover.

16. The massage machine of claim 9, wherein the limb massage mechanism further comprises bearings which are mounted between the first rotating shaft and the treatment pieces and used for supporting the treatment pieces and causing the treatment pieces to rotate on the rotating shaft.

17. The massage machine of claim 9, wherein the axis of the first rotating shaft is parallel to a plane where the bracket is located and a plane where the support housing is located.
